(19) United States
(12) Patent Application Publication
(10) Pub. No.: US 2002/0149802 A1
(43) Pub. Date: Oct. 17, 2002

(54) Image reading apparatus

(76) Inventor: Hidetoshi Aoki, Kawasaki-shi (JP)

Correspondence Address: Richard L. Schwaab, FOLEY & LARDNER, Washington Harbour, 3000 K Street, N.W., Suite 500, Washington, DC, 20007-5109, US

(21) Appl. No.: 09/835,851

(22) Filed: Apr. 17, 2001

(51) Int. Cl. H04N 1/40; H04N 1/04

(52) U.S. Cl. 358/461; 358/474

(57) ABSTRACT

An image reading apparatus is provided which is capable of determining an image reading start position without using expensive members such as photo sensors, nor needing positional adjustments. The image reading apparatus of the present invention sets a first carriage 21 at an image reading start position PS upon initialization thereof, carries out shading correction, sets again the first carriage 21 at the position PS, and reads, upon receipt of an image reading instruction, an image of a document placed on a document mounting glass plate 11 by means of the first carriage 21. In this case, a shading correction plate 13 holds reference position patterns K1 and K2 at a reference position PK apart a prescribed distance X0 from the position PS, and a control section detects the reference position by reading the reference position patterns by means of the first carriage, and performs subsequent control by recognizing, as the image reading start position, that position to which the image reading carriage is moved the prescribed distance X0 from the reference position thus detected.

### BACKGROUND OF THE INVENTION

1. Field of the Invention

The present invention relates to an image reading apparatus such as a scanner and the like, and more specifically, to an image reading apparatus in which, for example, an image reading carriage is set to an image reading start position upon initialization of the apparatus, shading correction is effected, and thereafter the image reading carriage is again set to the image reading start position, so that an image recorded in a document is read by the image reading carriage upon receipt of an image reading instruction.

2. Description of the Related Art

FIG. 4 is a structural view for explaining a conventional example of such a kind of image reading apparatus. This image reading apparatus is the one disclosed in Japanese Patent Application Laid-Open No. 5-328050, and includes a carriage 101 for optically scanning a document, a wire 103 having parts thereof connected with the carriage 101 and being wrapped under tension around pulleys 104, a pulse motor 102 for driving the carriage 101 to reciprocate through the wire 103, a motor driver 108 for driving the pulse motor 102, and a photo sensor 106 for detecting when the carriage 101 comes to an image reading start position, and a CPU 107 for controlling the operations of these components elements. In this case, the CPU 107 determines the image reading start position based on the detection of a position detecting flag 105 integrally mounted on the carriage 101 by means of the photo sensor 106.

In the conventional image reading apparatus as described above, since the CPU 107 has to determine the image reading start position by detecting the position detecting flag attached to the carriage 101 through the photo sensor 106, it is necessary to use an expensive member like the photo sensor 106 and a plate member like the flag 105, thus preventing reduction in the cost of the apparatus. In addition, adjustments of mutual positions of these members are not easy, thus readily causing errors in mounting positions thereof. As a result, there arises a fear that errors would be easily caused in the reading start position, making it impossible to set the carriage 101 to its proper and correct position.

### SUMMARY OF THE INVENTION

The present invention is intended to solve the said problems, and has for its object to provide an image reading apparatus which is capable of determining an image reading start position with high accuracy without using expensive members, and nor requiring positional adjustments.

In order to solve the problems referred to above, the present invention resides in an combination of an image reading carriage; a reference position pattern element provided on a prescribed location in such a manner that it is able to be read by the image reading carriage which is caused to run; and a control section for detecting a reference position based on the reference position pattern element thus read and setting the image reading carriage at a prescribed position based on the reference position thus detected.

According to such a construction, it is not necessary to mount a sensor for positional detection on the image reading apparatus, and hence a mere reference position pattern element may be provided at a prescribed location. As a result, mounting errors are not easily caused, thus enabling accurate position detection. In addition, since an expensive sensor is not needed, the low cost can be achieved.

Moreover, in the image reading apparatus of the present invention, provision is made for a shading plate having a shading pattern formed thereon for performing shading correction, and the reference position pattern element is formed on the shading plate at a portion thereof unprovided with the shading pattern.

The shading plate is usually provided at an end of the document mounting plate with high mounting accuracy. Thus, forming the reference position pattern element on the shading plate at its portion unprovided with the shading pattern serves to provide the reference position pattern element with extreme ease and high accuracy.

Further, in the present invention, the reference position pattern element comprises a straight line having an inclination of a prescribed angle with respect to a main scanning direction of the image reading carriage.

Thus, since the reference position pattern element is comprised of the straight line inclined at the prescribed angle in the direction of the main scanning direction, it is possible to read the reference position pattern element by means of the image reading carriage in a reliable manner. In addition, the displacement of the reference position pattern element can be continuously read in accordance with the movement of the image reading carriage, so that it becomes easy to predict when the image reading carriage reaches a prescribed position, thereby making it possible to accurately stop the image reading carriage at the prescribed position.

Furthermore, in the present invention, the reference position pattern element comprises at least two reference position patterns with a prescribed distance provided therebetween in an auxiliary scanning direction of the image reading carriage, the at least two reference position patterns being inclined with respect to the main scanning direction in an opposite relation to each other. The control section reads the two reference position patterns by means of the image reading carriage, and detects, as the reference position, the position at which the distance between the two reference position patterns in the main scanning direction becomes a prescribed value.

With such a construction, by setting the distance between the two reference position patterns to a prescribed value, the reference position can be easily adjusted.

Still further, in the present invention, the control section reads the reference position pattern element by first moving the image reading carriage a prescribed distance forwardly in an auxiliary scanning direction and then moving it rearwardly.

According to such a construction, by suitably determining the prescribed distance when the image reading carriage is stopped at a location rearwardly of the reference position pattern element, the image reading carriage is caused to first move forwardly beyond the reference position pattern element and then backwardly so as to find the reference position pattern element. As a result, the reference position pattern element can be detected reliably irrespective of the stopped position of the image reading carriage.

Moreover, in the present invention, the prescribed distance is greater than a distance within which the image reading carriage is able to move before reaching an auxiliary scanning range, and less than a distance within which the image reading carriage is able to move after passing the the auxiliary scanning range.

According to such a construction, the image reading carriage can detect the reference position pattern element, and it is possible to prevent the image reading carriage from colliding with movement limit ends upon initialization in the state of ordinary use.

Besides, in the present invention, the control section detects the reference position by reading the reference position pattern element by means of the image reading carriage, makes the image reading carriage move a prescribed distance from the reference position to the image reading start position, thereafter further moves it to a shading correction pattern side to perform shading correction, and then moves the image reading carriage to the image reading start position again to make it stand by there until an image reading instruction is given.

According to such a construction, the image reading carriage can always be made to stand by at a correct waiting position, and hence it becomes possible to perform reliable image reading.

### DESCRIPTION OF THE DRAWINGS

FIG. 1(a) is a cross sectional view illustrating an embodiment of an image reading apparatus of the present invention.

FIG. 1(b) is a plan view illustrating a shading correction plate employed in the image reading apparatus of FIG. 1(a).

FIG. 2 is a flow chart for explaining a control method for a first carriage of the image reading apparatus illustrated in FIGS. 1(a) and 1(b).

FIG. 3(a) is a cross sectional view illustrating another embodiment of an image reading apparatus of the present invention.

FIG. 3(b) is a plan view illustrating a shading correction plate employed in the image reading apparatus of FIG. 3(a).

FIG. 4 is a structural view illustrating an conventional example of an image reading apparatus.

### DESCRIPTION OF THE PREFERRED EMBODIMENTS

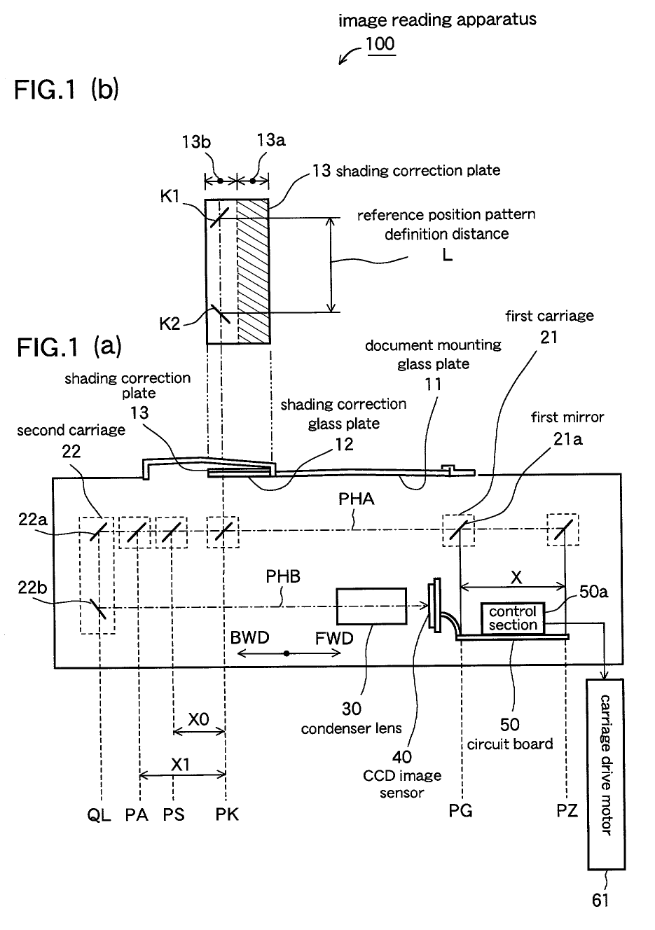

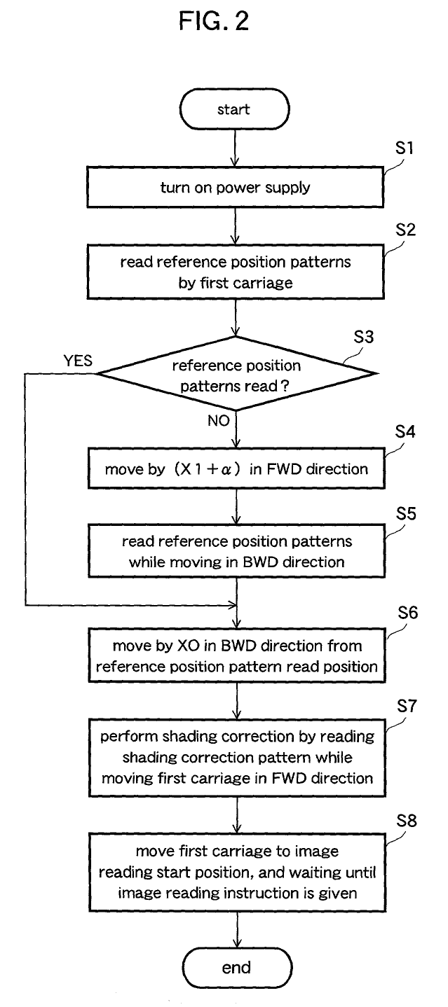

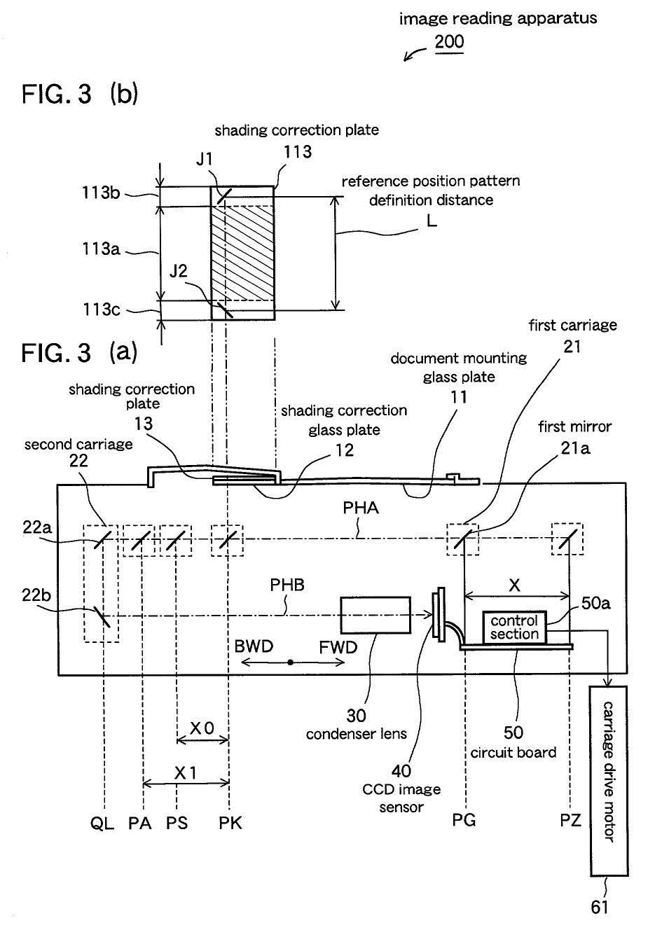

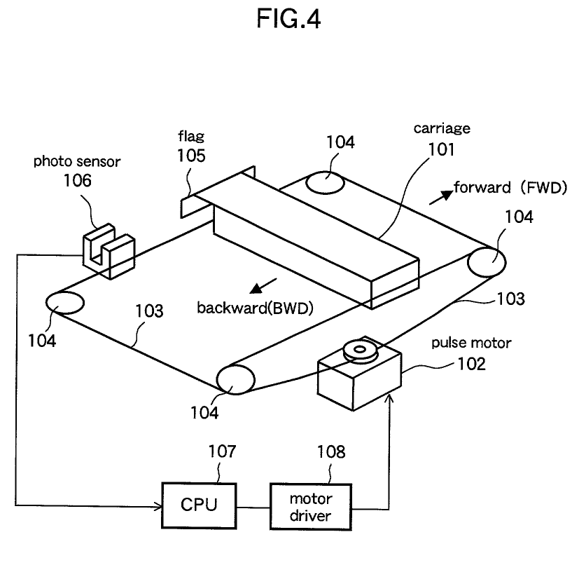

In the following, embodiments of the present invention will be described while referring to the accompanying drawings. FIG. 1(a) is a cross sectional view illustrating an embodiment of an image reading apparatus of the present invention, and FIG. 1(b) is a plan view illustrating a shading correction plate used in the image reading apparatus of FIG. 1(a). FIG. 2 is a flow chart for explaining a control method for a first carriage of the image reading apparatus illustrated in FIG. 1. FIG. 3(a) is a cross sectional view illustrating another embodiment of an image reading apparatus of the present invention, and FIG. 3(b) is a plan view illustrating a shading correction plate used in the image reading apparatus of FIG. 3(a). In the image reading apparatuses illustrated in FIG. 1(a) and FIG. 3(a), the direction perpendicular to the surface of a drawing sheet is a main scanning direction, and the direction parallel to the drawing sheet surface to the right or left (the direction designated by an arrow FWD or BWD) is an auxiliary scanning direction.

A document mounting glass plate 11 is horizontally arranged on an upper surface of an image reading apparatus (scanner) 100 of FIGS. 1(a) and 1(b), and a shading correction glass plate 12 is arranged adjacent the document mounting glass plate 11 and on the same plane as the document mounting glass plate 11. The shading correction glass plate 12 is formed of the same material and has the same thickness as the document mounting glass plate 11. Moreover, a shading correction plate 13 having a shading correction pattern, etc., recorded thereon is arranged on an upper surface of the shading correction glass plate 12. Thus, when a document and the shading pattern are read from under these glass plates 11 and 12, it is possible to read them in the same condition.

As for the patterns recorded on the shading correction plate 13 used in this embodiment, as illustrated in FIG. 1(b), the shading correction pattern is recorded in a first area 13a designated by slant lines, and reference position patterns K1 and K2 are also recorded in a second area 13b for detecting a reference position.

Under the document mounting glass plate 11 and the shading correction glass plate 12, there is arranged a first carriage (image reading carriage) 21 which is movable in the auxiliary scanning directions in a wider area than the area in which these glass plates exist. This first carriage 21 having a first mirror 21a incorporated therein moves while maintaining a predetermined spacing or distance between the document mounting glass plate 11 and the shading correction glass plate 12 and reads the document on the document mounting glass plate 11, or the reference position patterns K1 and K2 recorded on the shading correction plate 13 for the detection of the reference position, or the shading correction pattern for shading correction. The light of the image or the pattern(s) read by the first carriage 21 is reflected by the first mirror 21a of the first carriage 21, advancing in a direction of an arrow BWD along an optical path PHA parallel to the document mounting glass plate 11.

In the above case, it is constructed such that when the movement of the first carriage 21 is stopped during its usual or ordinary operation (including the case where the supply of electric power is suddenly interrupted), the first carriage 21 stops at a location from a limit position PA to a reading limit position PG (auxiliary scanning ending edge which is an outer edge of the document mounting glass plate 11). That is, the first carriage 21 is set in such a manner that it never moves to a section X between the reading limit position PG and the limit position PZ. The first carriage 21 is moved to or stopped at this section only when it is forced to move in the direction of the arrow FWD in the case of detecting the reference position, or when it is forced to move by means of a special operation of an engineer in the case of maintenance or the like, In this embodiment, the reference position PK is defined as a position where a distance between two points, at which the reference position patterns K1 and K2 of the shading correction plate 13 intersect an imaginary line which extends in the main scanning direction, becomes equal to a reference position pattern definition distance L. A reading start position PS is located at a distance X0 from the reference position PK, and this position is near the limit position PA (distance X1 from the reference position PK; X1<X X1=X0+α) beyond an area right under the shading correction glass plate 12 (in other words, it is set such that the reference position PK is at the distance X0 from the image reading start position PS). Moreover, the limit positions PA and PZ are the positions beyond which the first carriage 21 is mechanically restricted from moving.

The light (image) reflected by the first mirror 21a of the first carriage 21 advances along the optical path PHA, and is received by a second carriage 22. The second carriage 22 has a second mirror 22a and a third mirror 22b incorporated therein, and the light received from the first carriage 21 is reflected by the second and third mirrors 22a and 22b whereby the direction of the light is changed by 90° through each reflection, advancing along an optical path PHB in parallel to the optical path PHA but in the opposite direction. The light advancing along the optical path PHB passes through a condenser lens 30 and is focused on a CCD image sensor 40 whereby it is delivered or transferred to an image processing circuit (control section 50a) built into a circuit board 50. In this case, a position QL of the second carriage 22 illustrated in FIG. 1(a) is the position thereof when the first carriage 21 is located at the limit position PA. As the first carriage 21 moves at a certain speed a certain distance from the limit position PA in the direction of the arrow FWD, the second carriage 22 travels at half the speed only half the distance in the same direction of the arrow FWD. The movements of these carriages are similar for the direction of the arrow BWD. That is, even if the first carriage 21 moves to any position, the second carriage 22 travels in such a manner as to always make constant the length of the optical path from the first carriage 21 to the condenser lens 30. Here, note that these carriages 21 and 22 are driven by a carriage drive motor 61 based on a control signal from the control section 50a.

Next, the control operation of the control section 50a built into the circuit board 50 of the image reading apparatus 100 illustrated in FIG. 1 will be described while referring to a flow chart of FIG. 3. In the image reading apparatus 100, the first carriage 21 is stopped at a location between the limit position PA and the reading limit position PG before the power supply is turned on. Then, when the power supply is turned on (step S1), the reference position patterns K1 and K2 are read through the first carriage 21 at that time (step S2). After the reference position patterns K1 and K2 are read, it is determined whether the position where the distance between two points, at which these reference position patterns intersect an imaginary line extending in the main scanning direction, is equal to the reference position pattern definition distance L is detected as the reference position PK (step S3). If the reference position PK is not detected (NO in step S3), the first carriage 21 is forced to move by a distance (X1+α) in the direction of the arrow FWD (step S4). The purpose of this movement is to make the first carriage 21 go to the right side from the reference position PK (to the side of the limit position PZ) without fail. Note that this distance (X1+α) is set larger than the distance (X1), within which the first carriage 21 can be moved before reaching an auxiliary scanning range, but smaller than the distance (X) within which it can be moved after passing the auxiliary scanning range, so that the carriages 21 and 22 are prevented from moving to collide with opposite stop ends.

After the first carriage 21 has traveled by the distance (X1+α) in the direction of the arrow FWD, the reference position patterns K1 and K2 are then read while moving the first carriage 21 in the direction of the arrow BWD, whereby the position of the reference position pattern definition distance L is detected as the reference position PK (step S5). The first carriage 21 having traveled to the reference position PK is further moved by the distance X0 to the image reading start position PS on the side of the limit position PA (step S6). Then, shading correction is performed by reading the shading correction pattern while moving the first carriage 21 in the direction of the arrow FWD (step S7). After the shading correction is completed, the first carriage 21 is driven to travel to the image reading start position PS again where it is made to stand by until an image reading instruction is given (step S8). As can be clearly seen from this embodiment, the image reading apparatus does not use a photo sensor as employed in the conventional apparatus for the determination of the image reading start position PS, but instead makes such a determination by recording, through printing or the like, the reference position patterns K1 and K2 on the shading correction plate 13 which has already been arranged, and by reading it with the use of the existing first carriage 21 (image reading carriage).

Embodiment 2

Now, reference will be made to another embodiment of the present invention while referring to FIG. 3(a) and FIG. 3(b). In this image reading apparatus 200, a shading correction plate is different from the one shown in FIG. 1. That is, in this embodiment, a shading correction plate 113 has a central part 113a used for a shading correction pattern, and two portions 113b and 113c near an outer edge thereof used for reference position patterns J1 and J2. The positions and shapes of the reference position patterns J1 and J2 are the same as those of the reference position patterns K1 and K2, and hence the control section 50a can determine the image reading start position PS, etc., substantially in the same manner. It is to be noted that in the above-mentioned embodiment, the reference position PK is determined by detecting the reference position pattern definition distance L between the reference position patterns K1 and K2, but if accuracy can be maintained, the reference position PK may be determined only by detecting some pattern(s) disposed at the reference position.

According to the embodiments described above, there are disclosed the following forms of image reading apparatuses.

(1) An image reading apparatus comprising: an image reading carriage; a shading plate having a shading pattern formed thereof for performing shading correction and a reference position pattern element formed at a predetermined portion thereof unprovided with the shading pattern, the reference position pattern element being read by the image reading carriage which is driven to run; and a control section for detecting a reference position based on the reference position pattern element thus read and setting the image reading carriage at a prescribed position based on the reference position thus detected.

(2) In an image reading apparatus in which an image reading carriage is set at an image reading start position upon initialization of the apparatus, and after shading correction is made, the image reading carriage is again set at the image reading start position, and upon receipt of an image reading instruction, the image reading carriage reads an image recorded on a document, the image reading apparatus comprising: reference position pattern holding means for holding a reference position pattern element at a reference position apart a prescribed distance from the image reading start position; and a control section for detecting a reference position based on the reference position pattern element read by the image reading carriage, and recognizing, as the image reading start position, that position to which the image reading carriage is moved a prescribed distance from the detected reference position thereby to perform subsequent control operation.

(3) An image reading apparatus comprising: a document mounting glass table on which a document in the form of an object to be read is mounted; a shading correction glass plate arranged adjacent and along the same plane as the document mounting glass table, with a shading correction plate having a shading correction pattern recorded thereon being placed thereon; an image reading carriage being movable in a section in which both of the glass plates are arranged while maintaining a constant distance between the glass plates, the image reading carriage being movable rectilinearly in an auxiliary scanning direction from the image reading start position outside a section where the shading correction pattern and the document are arranged, for reading the shading correction pattern and an image on the document; reference position pattern holding means for holding a reference position pattern element at a reference position at which a distance from the image reading start position is defined in advance; and a control section for detecting the reference position based on the reference position pattern element read by the image reading carriage, driving the image reading carriage to move a prescribed distance from the reference position to the image reading start position, thereafter moving the image reading carriage toward a shading correction pattern side to perform shading correction, and then driving again the image reading carriage to move to the image reading start position where it is made to stand by until an image reading instruction is given.

(4) The image reading apparatus wherein the reference position pattern holding means comprises a portion of the shading correction plate in which there is no shading correction pattern, and the reference position pattern element recorded on that portion comprises two straight lines each having an inclination with respect to a first imaginary line extending in an auxiliary scanning direction on the shading correction plate, and arranged on opposite sides of the first imaginary line so as to be in axial symmetry with respect to the first imaginary line, and the control section reads these two straight lines by means of the image reading carriage, and detects, as the reference position, that position at which a distance between points at which the two straight lines intersect a second imaginary line extending in a main scanning direction is equal to a predetermined reference position pattern definition distance.

An image reading apparatus according to the present invention constructed as explained above can achieve the following advantage. That is, a control section is able to detect a reference position by reading a reference position pattern element through an image reading carriage, and determine, as an image reading start position, the position to which the image reading carriage is moved a prescribed distance from the reference position thus detected. Therefore, it is not necessary to use expensive parts such as photo sensors, etc., for the determination of the image reading start position as in the conventional apparatuses, and hence there is no need for positional adjustments of those parts. As a result, an image reading apparatus can be provided which is low in cost, but is still capable of being set at a prescribed position with high accuracy.

What is claimed is:

1. An image reading apparatus comprising:
an image reading carriage;
a reference position pattern element provided on a prescribed location in such a manner that it is able to be read by said image reading carriage which is caused to run; and
a control section for detecting a reference position based on the reference position pattern element thus read and setting said image reading carriage at a prescribed position based on the reference position thus detected.

2. The image reading apparatus as set forth in claim 1, further comprising a shading plate having a shading pattern formed thereon for performing shading correction, said reference position pattern element being formed on said shading plate at a portion thereof unprovided with said shading pattern.

3. The image reading apparatus as set forth in claim 1, wherein said reference position pattern element comprises a straight line having an inclination of a prescribed angle with respect to a main scanning direction of said image reading carriage.

4. The image reading apparatus as set forth in claim 3, wherein said reference position pattern element comprises at least two reference position patterns with a prescribed distance provided therebetween in an auxiliary scanning direction of said image reading carriage, said at least two reference position patterns being inclined with respect to said main scanning direction in an opposite relation to each other, and said control section reads said two reference position patterns by means of said image reading carriage, and detects, as the reference position, the position at which the distance between said two reference position patterns in said main scanning direction becomes a prescribed value.

5. The image reading apparatus as set forth in claim 1, wherein said control section reads said reference position pattern element by first moving said image reading carriage a predetermined distance forwardly in an auxiliary scanning direction and then moving it rearwardly.

6. The image reading apparatus as set forth in claim 5, wherein said prescribed distance is greater than a distance within which said image reading carriage is able to move before reaching an auxiliary scanning range, and less than a distance within which said image reading carriage is able to move after passing said said auxiliary scanning range.

7. The image reading apparatus as set forth in claim 2, wherein said control section detects the reference position by reading said reference position pattern element by means of said image reading carriage, makes said image reading carriage move a prescribed distance from said reference position to said image reading start position, thereafter further moves it to a shading correction pattern side to perform shading correction, and then moves said image reading carriage to said image reading start position again to make it stand by there until an image reading instruction is given.
